(19) United States
(12) Patent Application Publication
(10) Pub. No.: US 2024/0378994 A1
(43) Pub. Date: Nov. 14, 2024

(54) SYSTEMS AND METHODS FOR COORDINATING AUTONOMOUS VEHICLES IN AN INTERSECTION

(71) Applicant: Robotic Research OpCo, LLC, Clarksburg, MS (US)

(72) Inventors: Alberto Daniel Lacaze, Potomac, MD (US); Joseph Putney, Waterford, VA (US); Karl Nicholas Murphy, Cocoa Beach, FL (US)

(21) Appl. No.: 18/692,712

(22) PCT Filed: Sep. 23, 2022
(86) PCT No.: PCT/US22/76894

§ 371 Date: Mar. 15, 2024

Related U.S. Application Data
(60) Provisional application No. 63/246,896, filed on Sep. 22, 2021.

(51) Int. Cl. G08G 1/01; B60W 40/04; G08G 1/005; G08G 1/07; G08G 1/16; H04W 4/40

(52) U.S. Cl. CPC G08G 1/0145; B60W 40/04; G08G 1/005; G08G 1/07; G08G 1/166; H04W 4/40; B60W 2520/10; B60W 2710/20; B60W 2720/10

(57) ABSTRACT

Systems and methods for automatic and efficient intersection traffic control for autonomous or semi-autonomous ground vehicles. In accordance with some embodiments, the systems and methods comprise a centralized controller associated with an intersection that comprises a sensor for detecting data corresponding to ground vehicles approaching the intersection and a controller for generating and transmitting an instruction to at least one of the ground vehicles approaching the intersection, the instruction for causing the at least one vehicle to adjust at least one of its speed and path in order to avoid a collision with another of the ground vehicles.

### CROSS-REFERENCE TO RELATED APPLICATIONS

This application claims the benefit of and priority to, and is a § 371 National Stage Filing of International Patent Application No. PCT/US22/76894 filed on Sep. 23, 2022 and titled “SYSTEMS AND METHODS FOR COORDINATING AUTONOMOUS VEHICLES IN AN INTERSECTION,” which itself claims benefit of and priority under 35 U.S.C. § 119 (e) to, and is a Non-provisional of, U.S. Provisional Patent Application No. 63/246,896 filed on Sep. 22, 2021 and titled “SYSTEMS AND METHODS FOR COORDINATING AUTONOMOUS VEHICLES IN AN INTERSECTION”, the disclosures of each hereby incorporated by reference herein in their entireties.

### SUMMARY

Embodiments of the disclosure provide systems and/or methods for efficiently coordinating autonomous or semi-autonomous vehicles through an intersection.

### BACKGROUND

Human drivers do not have the ability to efficiently traverse a busy intersection without following current traffic rules including stop signs, traffic lights, and/or other intersection traffic rules. The ability to pass through an intersection at or near full speed while vehicles moving through the same intersection transverse to the vehicle are doing the same requires a precision in timing that is unattainable for humans. However, autonomously or semi-autonomously controlled vehicles (referred to collectively herein as autonomous vehicles or ground vehicles, for purposes of brevity) can have such an ability, if provided with the required inputs, instructions and/or data.

The human sensor suite (eyes, ears, etc.) was optimized over millions of years to perform certain tasks. This is particularly noteworthy because humans are exceptionally challenged at measuring distances and speeds past a few meters. Because human capabilities for evaluating crossing traffic and estimating the speed of others and their own speed are so poor, vehicle intersections and crossing such without having any external aid can be dangerous. It is not surprising, therefore, that in order to maintain civility, rules of the road were created to guide and improve safety. For example, in intersections of any complexity stop signs and traffic lights (semaphores) are used to help maintain control and safety. Such systems have worked over many years to control vehicles with human drivers because they create decision points that are relatively easily processed by humans, even with the inherent limitations embodied in their sensor suite. Such existing aids at intersections are geared towards harnessing the type of data inputs that humans are generally competent at processing. For example, even though humans are not very good at detecting distances, most humans are good at detecting the color of a traffic signal, therefore, the decision of when to cross can be made by the classification of the color of the light rather than by determining the distance or speed of the cross traffic. In a similar manner, stop signs and four ways stops force humans to make decision in areas in which their sensor suite is more reliable (e.g., at smaller distances, lower speeds and shorter ranges) and therefore avoiding accidents. The obvious downside of this compromise in the form of these mechanisms (rules and physical stop mechanisms such as stop signs and traffic signals) is that they make traffic flow less efficient from a throughput standpoint and from an energy standpoint, often causing long back-ups, traffic jams, and unnecessarily burn more fuel at busy intersections.

Robots and autonomous vehicles have fundamentally different sensor suites than humans. For example, LADARs (or LiDARs) and radars provide direct measurements of distances and velocities. As another example, many autonomous vehicles have wheel encoders and GPS that allows them to measure their own position and speed very accurately. Applicant has recognized that the sensor suites of robots and autonomous vehicles may be utilized to provide enhanced and advantageous mechanism for optimizing traffic flow through intersections, as described herein.

Any of the various innovations and embodiments included in the disclosed subject matter herein can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Where applicable, some elements may be simplified or otherwise not illustrated in order to assist in the illustration and description of underlying features. For example, in some figures, some components have been illustrated using a partial or cutaway view in order to illustrate internal interaction of components. Throughout the figures, like reference numerals denote like elements. An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2A is a diagram of a system according to some embodiments;

FIG. 2B is a distance-time plot of a system according to some embodiments;

FIG. 3A is a diagram of a system according to some embodiments;

FIG. 3B is a distance-time plot of a system according to some embodiments;

FIG. 3C is a distance-time plot of a system according to some embodiments;

FIG. 3D is a distance-time plot of a system according to some embodiments;

FIG. 3E is a distance-time plot of a system according to some embodiments;

FIG. 3F is a distance-velocity plot of a system according to some embodiments;

FIG. 3G is a diagram of a system according to some embodiments;

FIG. 4A is a diagram of a system according to some embodiments;

FIG. 4B is a diagram of a system according to some embodiments;

FIG. 5 is a block diagram of a controller according to some embodiments; and

FIG. 6 is a flow diagram of an example process consistent with some embodiments.

### DETAILED DESCRIPTION

### I. Introduction

Embodiments described herein are provided to at least in part alleviate various deficiencies of current traffic control of one or more vehicles arriving at an intersection or any other common driving space where the vehicles' driving paths may cross. While current autonomous vehicle are supplied with sensors (e.g., light and/or other visual sensors and ultrasonic sensors) for detecting traffic light status, the flow of the vehicles that include these sensors and autonomous driving ability is no different than, and just as inefficient as, current non-autonomous driving flow. Embodiments herein are operable to automatically and efficiently manage the flow of one or more autonomous and/or traditional non-autonomous vehicles through an intersection via an intersection controller (or multiple controllers communicating with one another) programmed as described herein.

Intersections generally are governed by various visual aids such as stop signs and traffic lights that function to embody traffic rules associated with them to prevent two vehicles from occupying the same space at the same time. These rules generally involve allowing only one direction of flow through an intersection at a time. By allowing only one direction of flow, however, means that the flow of traffic in the other direction must come to a stop for a time. Once the vehicles travelling in other direction is allowed to proceed through the intersection, the vehicles moving in the first direction of flow now must come to a stop for a time. Traffic lights may be timed such that higher density traffic (e.g., major roads at an intersection with minor roads) is prioritized and may have less stopped time. Intersections may utilize sensors in the road to detect when vehicles moving in a direction are waiting and change the lights to allow them through. All of these rules and systems are in place to allow vehicles to traverse an intersection without collisions with other vehicles, but at the cost of speed and efficiency (e.g., fuel consumption, time stopped, energy loss due to slowing from normal road speed to zero and back to normal road speed repeatedly, and/or overall intersection throughput).

In accordance with at least some embodiments described herein, electronic and automated intersection traffic systems or controllers are provided, which systems or controllers are operable to compute and/or detect an initial preferred route for one or more vehicles. For example, such a system may include a mechanism operable to receive from, or identify or infer based on data detected from, at least one of the approaching vehicles an indication of the vehicle's desired path and/or route (e.g., x, y coordinates and a time component t). In some embodiments, such a system may further be operable to receive from, or identify or infer based on data detected from, the approaching vehicle(s) an indication or description of the computed space, speed, and time necessary to follow that route or be operable to compute this from the data received from the vehicle(s). As the vehicle(s) approach the intersection, the system may be operable to manage at least some of the approaching vehicle(s) (e.g., the paths, speeds, velocities and/or spaces of the approaching vehicle(s)) such that the trajectories do not create collisions.

For example, the system and methods may be operable to generate and transmit instructions to those vehicles approaching the intersection with which it can communicate (e.g., autonomous or semi-autonomous vehicles that are operable to receive and act upon such instructions), the instructions causing such vehicles to adjust at least one of their speeds or paths. In accordance with some embodiments, the systems and methods may be operable to recognize and take into account various relevant factors when generating such instructions, such as, without limitation: (i) the inability to communicate or instruct some of the approaching vehicles (e.g., vehicles which are not equipped with communication means for communicating with a controller of the intersection system); (ii) physical obstacles in the paths of any of the approaching vehicles (e.g., potholes, animals, debris in the road, etc.); (iii) pedestrians or other potential interferences approaching the intersection or paths of the approaching vehicles; and (iv) emergency vehicles approaching the intersection which may be prioritized for traversing the intersection.

### II. Intersection Control Systems

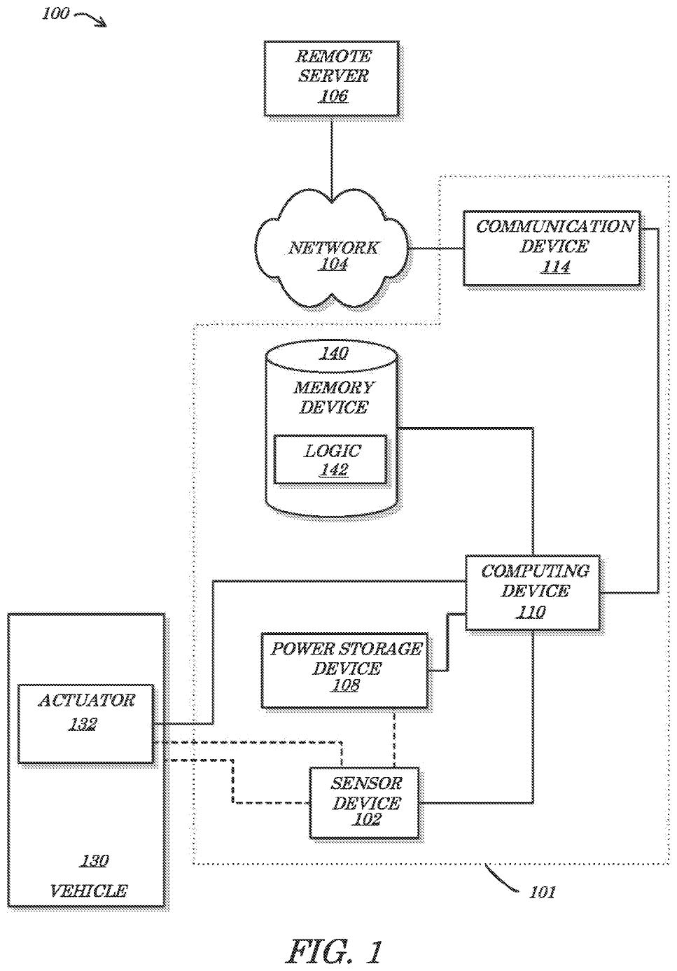

Referring to FIG. 1, a block diagram of an example system 100 according to some embodiments is shown. In some embodiments, the system 100 may comprise an intersection controller 101 that corresponds to a ground intersection being approached by a vehicle 130, the intersection controller comprising a computing device 110, a sensor device 102, a memory device 140 (which comprises at least logic 142), power storage device 108 and a communication device 114. The intersection controller may be operable, for example via communication device 114 and via a network 104 (e.g., one or more communications objects such as a wireless transceiver, computer bus, wires, cables, etc.), to communicate (directly or indirectly, continuously, periodically or occasionally) with a remote server 106. In some embodiments, a remote server 106 may not be utilized and/or preferred (e.g., all of the functionality described herein as being performed with the aid of a remote server 106 may instead be performed locally by computing device 110). For example, in accordance with some embodiments the intersection controller 101 may be operable to receive data from sensor 102 and vehicle 130, utilize logic 142 and/or information from remote server 106, to manage the path, trajectory, speed or other manner of crossing the corresponding intersection by vehicle 130 and other vehicles approaching the corresponding intersection.

Fewer or more components 102, 104, 106, 108, 110, 114, 130, 132, 140, 142 and/or various configurations of the depicted components 102, 104, 106, 108, 110, 114, 130, 132, 140, 142 may be included in the system 100 without deviating from the scope of embodiments described herein. In some embodiments, the components 102, 104, 106, 108, 110, 114, 130, 132, 140, 142 may be similar in configuration and/or functionality to similarly named and/or numbered components as described herein. In some embodiments, the system 100 (and/or portion thereof) may comprise a system programmed and/or otherwise configured to execute, conduct, and/or facilitate one or more methods as described herein.

In some embodiments, the sensor device 102 may comprise an imaging, pressure sensing, motion sensing, location sensing, time sensing, and/or other input device that is disposed to capture, record, and/or monitor data descriptive of one or more vehicles 130. It should be noted that although FIG. 1 illustrates a single vehicle 130, this is for the sake of clarity and should not be interpreted in a limiting fashion. The (e.g., the position, speed (collectively velocity), and/or planned route of the vehicle 130 and other vehicles in the vicinity of the vehicle 130. According to some embodiments, an actuator 132 may be coupled with the throttle and/or steering mechanism of the vehicle 130 to automatically accelerate, decelerate, and/or change direction of the vehicle 130 (e.g., slowing the vehicle down, speeding the vehicle up, changing lanes, and/or turning onto another road). In some embodiments, for example, a processor of the vehicle 130 (not shown) may be programmed to utilize the actuator 132 to control the motion of the vehicle 130 in accordance with instructions received from an intersection controller (e.g., as embodied in computing device 110). In other embodiments, an intersection controller (e.g., as embodied in computing device 110) may be operable to communicate with, or control, actuator 132 directly.

According to some embodiments, the sensor device 102 may be in communication with the computing device 110 and/or may provide indications of the data obtained, received or sensed by the sensor device 102 to the computing device 110. According to some embodiments, the computing device 110 may be in communication with a memory device 140 (e.g., storing logic 142). In some embodiments, the data captured by sensor device 102 may additionally or alternately be provided from the sensor device 102 to the actuator 132. In some embodiments, the computing device 110 may execute logic (e.g., the logic 142) to compute location, speed and direction of movement, planned route, and/or time into and time out of a specified space (e.g., into and out of an intersection) of the vehicle 130 and/or other vehicles in the vicinity of the vehicle 130 (e.g., based on data received by/from sensor device 102). In some embodiments, computing device 110 may receive data indicative of vehicle 130 (e.g., data indicative of the speed, location, trajectory, path or space of vehicle 130) directly from vehicle 130 instead of, or in addition to, from sensor device 102. In some embodiments, sensor 102 may not be needed or desired.

The sensor device 102, in some embodiments, may comprise any type or configuration of device, sensor, and/or object that is capable of capturing imagery, motion, pressure, light, strain, temperature, and/or other data descriptive of the vehicle 130. The sensor device 102 may comprise, for example, an ultrasonic sensor, a RAdio Detecting And Ranging (RADAR) sensor, a Global Positioning System (GPS), and/or a camera and/or a ranging device such as a Light Detection and Ranging (LiDAR) device. In some embodiments, the sensor device 102 may comprise a multispectral imaging device capable of capturing three or four band imagery data (e.g., RGB plus Near IR). The imagery and/or other data captured by the sensor device 102 may generally comprise any type, quantity, and/or format of digital, analog, photographic, video, pressure, light, strain, temperature, flow, and/or other sensor data descriptive of the vehicle 130 or other vehicles approaching the intersection corresponding to sensor 102.

According to some embodiments, the sensor device 102 may communicate with the computing device 110, the actuator 132, and/or the remote server 106 to provide data captured by the sensor device 102 for analysis and/or assessment and/or causing automatic triggering events. According to some embodiments, the sensor device 102 may store and/or execute specially programmed instructions (such as a mobile device application) to operate in accordance with embodiments described herein. The sensor device 102 may, for example, execute one or more mobile device programs that activate and/or control the sensor device 102 and/or that send commands to one or more of the computing device 110, the actuator 132, and/or the power storage device 108 in response to detected data from the vehicle 130 or other vehicles approaching the intersection corresponding to sensor device 102.

The network 104 may, according to some embodiments, comprise a Local Area Network (LAN; wireless and/or wired), cellular telephone, Bluetooth® and/or Bluetooth® Low Energy (BLE), Near Field Communication (NFC), and/or Radio Frequency (RF) network with communication links between the computing device 110 (and/or the communication device 114) and the remote server 106 and/or other computing devices of other vehicles and/or intersections. In some embodiments, the network 104 may comprise direct communications links between any or all of the components 102, 108, 110, 114, 132, 140 of the system 100. The sensor device 102 may, for example, be directly interfaced or connected to the computing device 110 via one or more wires, cables, wireless links, and/or other network components, such network components (e.g., communication links) comprising portions of the network 104. In some embodiments, the network 104 may comprise one or many other links or network components other than those depicted in FIG. 1. The remote server 106 may, for example, be connected to the computing device 110 and/or the communication device 114 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102, 106, 108, 110, 114, 132, 140 of the system 100. The network 104 may comprise one or more cellular telephone networks with communication links between the remote server 106 and the communications device 114, for example, and/or may comprise a BLE, NFC, RF, and/or “personal” network comprising short-range wireless communications between the sensor device 102 and the computing device 110, for example.

In some embodiments, the remote server 106 may comprise one or more electronic and/or computerized processing devices, such as a computer server and/or server cluster communicatively coupled to interface with the communication device 114 (directly and/or indirectly; e.g., via the network 104). The remote server 106 may, for example, comprise one or more PowerEdge™ M910 blade servers manufactured by Dell®, Inc. of Round Rock, TX, which may include one or more Eight-Core Intel® Xeon® 7500 Series electronic processing devices. According to some embodiments, the remote server 106 may be located remotely from the intersection controller 10, components thereof (e.g., sensor device 102, computing device 110, communication device 114) and/or the vehicle 130. The remote server 106 may be located in a server farm connected to an electrical grid (not shown), for example, while the communication device 114 may be located at the remote and/or off-grid site where waste fluid is directed through the vehicle 130. The remote server 106 may also or alternatively comprise a plurality of electronic processing devices located at one or more various remote sites and/or locations (e.g., a distributed computing and/or processing network).

According to some embodiments, the remote server 106 may store and/or execute specially-programmed instructions to operate in accordance with embodiments described herein. The remote server 106 may, for example, execute one or more programs that analyze data related to fuel consumption, intersection throughput, and/or other data related to overall intersection efficiency of the updated routes computed by the intersection controller 101 (e.g., by an on-board navigation computer or an intersection-specific navigation computer). According to some embodiments, the remote server 106 may comprise a computerized processing device, such as a PC, laptop computer, computer server, and/or other network or electronic device, operated to analyze intersection traffic patterns, fuel usage, and/or any other data associated with automatic control of vehicle in and around an intersection. In accordance with some embodiments, some or all of the functionality described herein as being performed by remote server 106 may alternatively or additionally be performed by computing device 110 or vice versa.

In some embodiments, the power storage device 108 may comprise any type, quantity, and/or configuration of devices and/or objects that are operable to store energy and/or power. The power storage device 108 may comprise, for example, one or more batteries, and/or capacitors. According to some embodiments, the power storage device 108 may comprise one or more 4.352 kWh, 170 Ah, 24-V Hawk™ standby batteries available from BigBattery.com of Chatsworth, CA.

In some embodiments, the computing device 110 may comprise one or more electronic and/or computerized processing devices, such as a computer server and/or server cluster communicatively coupled to interface with (directly and/or indirectly) the sensor device 102 and/or the memory device 140. The computing device 110 may, for example, comprise one or more PowerEdge™ M910 blade servers manufactured by Dell®, Inc. of Round Rock, TX, which may include one or more Eight-Core Intel® Xeon® 7500 Series electronic processing devices. According to some embodiments, the computing device 110 may be located remotely from the remote server 106. The computing device 110 may be located within a relatively short distance to the vehicle 130 (e.g., within a few feet or meters or within a quarter mile), for example, while the remote server 106 may be many miles away and only reachable via the communication device 114 via a long-range wireless network 104 (e.g., a cellular and/or satellite transmission network). The computing device 110 may also or alternatively comprise a plurality of electronic processing devices located at one or more various sites and/or locations (e.g., a distributed computing and/or processing network) comprising a plurality of vehicles 130.

In some embodiments, the communication device 114 may comprise any type, quantity, and/or configuration of communication and/or network devices such as one or more wireless and/or wired transceiver devices. The communication device 114 may comprise, for example, an Agilis™-AAV110 Series SATCOM transceiver available from Agilis™ Satcom of Ojai, CA and/or an airMAX™ GigaBeam Long-Range 60/5 GHz Radio with a 2-km range available from Ubiquiti™ Inc. of New York, NY.

In some embodiments, the actuator 132 may comprise any type, quantity, and/or configuration of device that is operable to control the speed and direction of the vehicle 130 (e.g., a throttle actuator, a brake actuator, and/or a steering wheel actuator) that is or becomes known or practicable. The actuator 132 may comprise a mechanical, hydraulic, and/or pneumatic linear actuator, a mechanical, hydraulic, and/or pneumatic rotary actuator, an electric actuator, and/or a magnetic actuator. The actuator may be operable to increase and/or decrease throttle opening, increase and/or decrease brake pressure, and/or turn the steering wheel to meet the route computed by the computing device 110.

In some embodiments, the memory device 140 may store various data relevant to the embodiments described herein. Examples of such data include, without limitation, (i) an initially planned route for the vehicle 130 or other vehicles approaching the corresponding intersection, (ii) a map or maps of the area, (iii) data indicative of other vehicles within a specified range of the vehicle 130 (e.g., the number, type, capabilities, paths, speeds, trajectories and/or instructions provided to such vehicles), (iv) the anticipated time for each vehicle through the corresponding intersection, (v) specific vehicle data for vehicles that are approaching the intersection, have passed through the intersection and/or are within a specified range of vehicle 130 (e.g., weight, engine size, fuel economy, priority, and/or load data related to each vehicle), (vi) specific vehicle instructions (e.g., not-to-exceed limitations for the actuator), (vii) current traffic conditions, (viii) historical traffic conditions based on relevant information (e.g., time of day, current construction limitations, and/or instructions), and/or (ix) a predetermined safety factor (e.g., a vehicle carrying dangerous chemicals or other cargo or an emergency vehicle may be predetermined to have a higher safety probability threshold than e.g. an unoccupied vehicle carrying non-fragile cargo) for each vehicle that are anticipated to cause various components of system 100 (e.g., the computing device 110, the sensor device 102, the actuator 132, and/or the power storage device 108) to operate in accordance with embodiments described herein.

In some embodiments, the memory device 140 may comprise any type, configuration, and/or quantity of data storage devices that are or become known or practicable. The memory device 140 may, for example, comprise an array of optical and/or solid-state hard drives configured to store data descriptive of the vehicle 130 and surrounding vehicles, road conditions, intersection state, user identifier data, image (and/or other sensor data) analysis data, image (and/or other sensor data) processing data, and/or various operating instructions, drivers, etc. In some embodiments, the memory device 140 may comprise a stand-alone and/or networked data storage device, such as a solid-state and/or non-volatile memory card (e.g., a Secure Digital (SD) card, such as an SD Standard-Capacity (SDSC), an SD High-Capacity (SDHC), and/or an SD extended-Capacity (SDXC), and any various practicable form-factors, such as original, mini, and micro sizes, such as those available from Western Digital Corporation of San Jose, CA). While the memory device 140 is depicted as a stand-alone component of the intersection controller 101 in FIG. 1, the memory device 140 may comprise multiple components. In some embodiments, a multi-component memory device 140 may be distributed across various devices and/or may comprise remotely dispersed components. Any or all of the sensor device 102, the computing device 110, the communication device 114, the power storage device 108, the actuator 132, and/or the remote server 106 may comprise the memory device 140 or a portion thereof, for example.

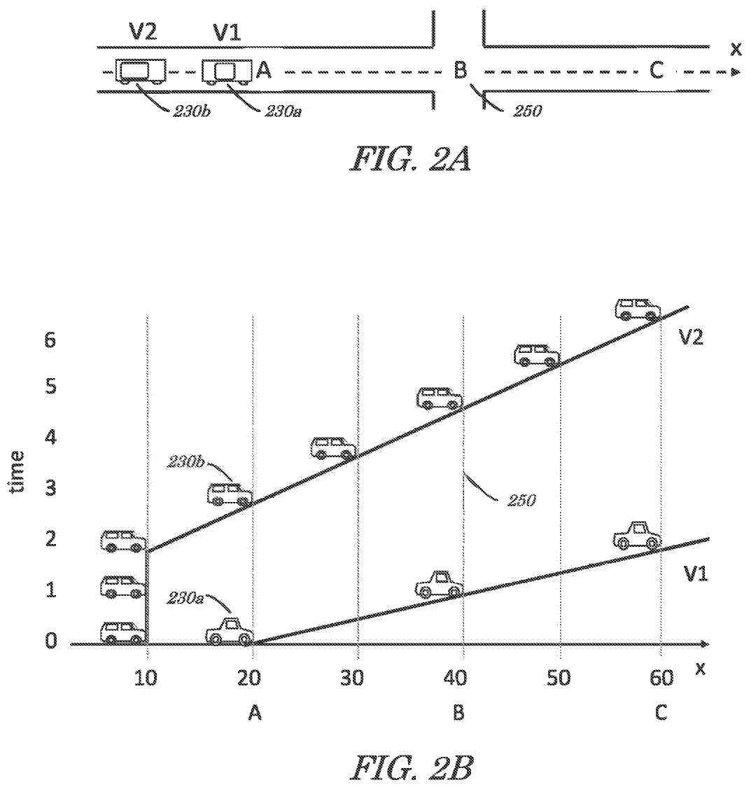

Referring now to FIG. 2A and FIG. 2B, illustrated therein is a non-limiting example of two vehicles entering an intersection 250, one behind the other. It should be noted that although only two vehicles are illustrated, this is for purposes of simplicity to describe some embodiments and that any number of vehicles may be within the scope of embodiments described herein. According to some embodiments, an automatic intersection control system, for example, may comprise the system 100 of FIG. 1 and may include the intersection controller 101 and a controller (not shown in FIG. 2A or FIG. 2B) or a plurality of controllers associated with each respective vehicle 230 herein.

According to embodiments described herein, an intersection controller 101 may utilize various methodologies, logic, data, calculations, assumptions and/or algorithms. In accordance with one embodiment, an x-y-time graph search is utilized. To explain such an embodiment, a few examples are presented with reference to the vehicles and intersection illustrated in FIG. 2. It may be assumed that the two vehicles illustrated in FIG. 2A and 2B are on a road heading in the x direction from A to B to C. Vehicle 230a (V1) is in front and the initial route includes a speed of 20 m/sec. Vehicle 230b (V2) starts 10 meters behind and the initial route includes it to be stationary for 2 seconds and then begin to move at in the x-direction at a speed of 10 m/sec. In some embodiments, the intersection controller may be integral with each vehicle 130 within an intersection, communicate with one another either directly or through the network 104 via their communication device 114, and/or include separate actuators 132 operably coupled to each vehicle's throttle, brakes, and/or steering mechanism.

Referring now to FIG. 2B, illustrated therein is a graph of the anticipated motion of the two vehicles 230a-b illustrated in FIG. 2A over time. The planned motion of vehicles 230a-b (e.g., as received from the respective vehicles) are plotted on a x-time plot. It should be noted that while the position-time plots are plotted in FIG. 2A with time on the horizontal axis, elsewhere in the present description there is plotting of the x-y motion against time and therefore time is plotted on the vertical axis.

It may be assumed, with respect to the vehicles represented in FIG. 2B, that vehicle 230a moves at 20 m/sec and, as illustrated in the graph of FIG. 2B, that it starts at position 20 at time 0, moves to 40 at time 1, and 60 at time 2. It may further be assumed, as illustrated in the graph of FIG. 2B, that vehicle 230b starts at 10, remains at 10 until time 2 (meaning there is an initial delay in the motion of vehicle V2), and then moves at 10 m/sec to 20 at time 3, 30 at time 4, etc.

In accordance with one embodiment, both vehicles 230a-b plan to drive in the same space (e.g., in the x-y coordinates) but at different times t. For example, both paths cross position B, but vehicle 230a is there 4 seconds earlier, at time 1, while vehicle 230b arrives at time 5. They are both at B, but at different times and therefore the planned paths do not collide.

The embodiments described herein recognize that vehicles take up space. When planning vehicle paths, it may be insufficient for an intersection controller (e.g., computing device 110, in coordination with logic 142, of intersection controller 101) to utilize data indicative of a static position of a portion or area of the relevant vehicles at a given point in time (e.g., data indicative of the front bumpers being at the same location at the same time); rather, the intersection controller may utilize logic that accounts for the length of the vehicle(s) as well as a safety distance. The embodiments described herein further recognize that vehicles need time to accelerate and the path of vehicle 230b would not go from 0 to 10 m/sec instantly (in some embodiments, the intersection controller may have access to acceleration and/or deceleration data or capabilities of various types, makes or models of vehicles that it can utilize to generate calculations, assumptions and/or instructions). A controller programmed in accordance with embodiments described herein may therefore take into account factors such as the space each relevant vehicle takes up (e.g., by receiving an indication of this from each vehicle, determining the information based on an image or visual inspection of the vehicle as it is approaching the intersection, or by assuming the information based on data accessible to the controller).

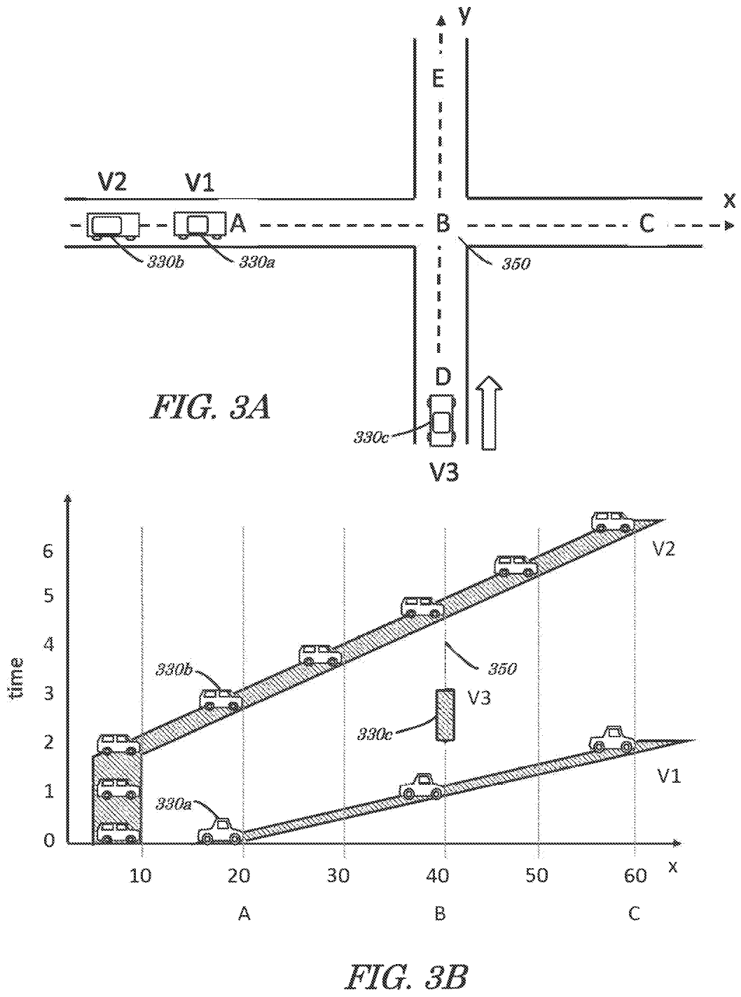

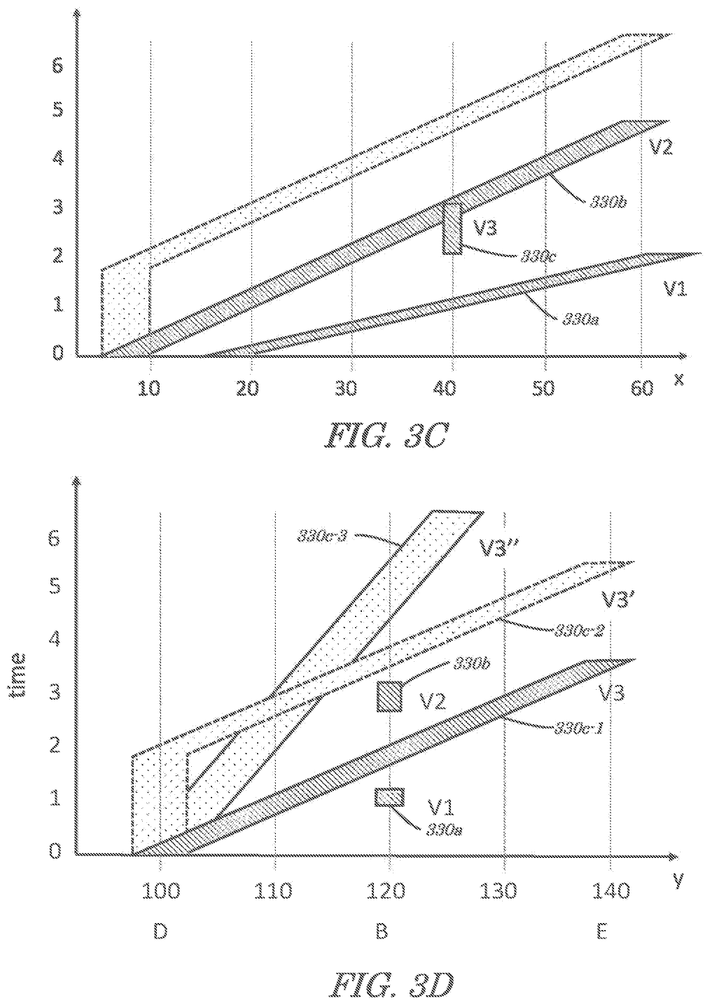

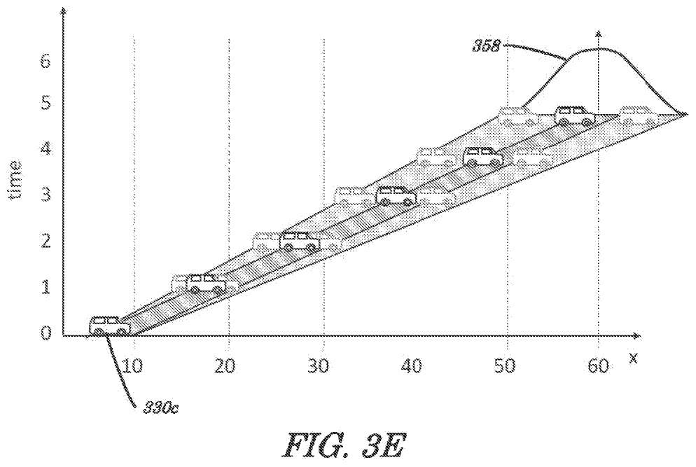

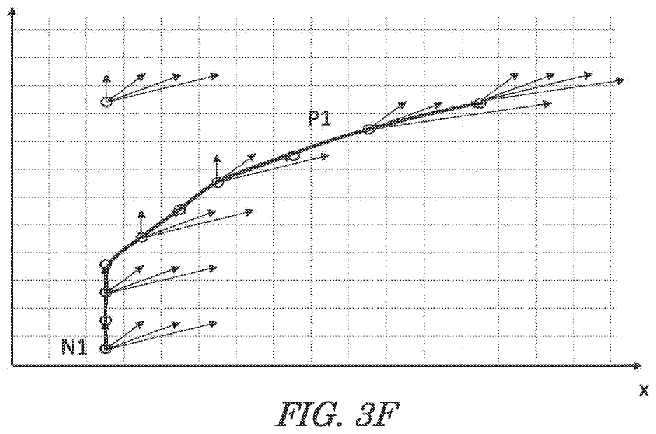

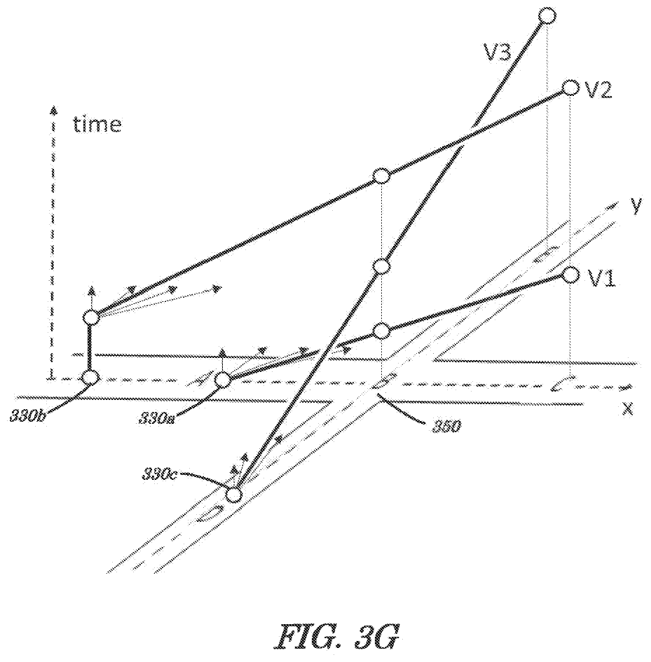

Turning now to FIGS. 3A and 3B, illustrated therein is an embodiment involving three vehicles rather than two (again, as noted in reference to FIGS. 2A and 2B, any number of vehicles may be utilized and the embodiments described herein are not limited or dependent upon any particular number of vehicles; the methodologies and logic described herein may be applied to any number of vehicles approaching a given intersection equipped with an intersection controller operable to perform the functionalities described herein). According to some embodiments, an automatic intersection control system may, for example, comprise the system 100 of FIG. 1 including a controller (not shown in FIG. 3A-3F) or a plurality of controllers associated with each vehicle 330 herein. FIG. 3A and FIG. 3B illustrate an intersection 350 similar to the intersection 250 of FIG. 2A, but at a point in time in which a third vehicle 330c (V3) is approaching the intersection 350 from a cross street. It should be assumed that vehicle 330a-b (V1 and V2) still have an initial route going from A to B to C, while vehicle 330c (V3) is planning on going from D through B to E. Initially, vehicle 330c is not in the intersection and is not blocking the ABC path. At some time later it will enter the intersection and block the A-B-C path at point B. At some time t after that, if vehicle 330c keeps moving, it will clear the intersection and will not block the A-B-C path. Thus, without the intervention of an intersection controller as described herein, there may or may not be a collision between the vehicles, depending on when each vehicle enters and exits the intersection at B. FIGS. 3A and 3B are included herein to illustrate that the methodologies and logic described herein may be applied to ever more complex vehicle scenarios at an example intersection.

Referring now to FIG. 3B, illustrated therein is a graph similar to FIG. 2B of the anticipated motion of the three vehicles 330a-c illustrated in FIG. 3A over time. The graph of FIG. 3B is based on the same assumptions with respect to the planned movement over time of vehicles 230a-b as had been utilized with respect to the graph of FIG. 2B (e.g., that there is an initial delay in the movement of vehicle V2). In this x-time plot, the third vehicle 330c of FIG. 3A is added to the graph illustrated in FIG. 2B. In this example, vehicle 330c enters the intersection 350 at time 2 and it exits at time 3. The intersection 350, point B, is at x-position 40. In addition, the position of both the front and back of 330a-b are also plotted (e.g., the lines have thickness depicting the length of each vehicle 330a-b). As illustrated in the plotted graphs, the vehicles do not collide. Vehicle 330c crosses the intersection 350 in-between vehicles 330a-b.

Referring now to FIG. 3C, illustrated therein is a graph of the anticipated motion of the three vehicles 330a-c illustrated in FIG. 3A over time and in which example the vehicle 330b (V2) does not delay its motion but instead immediately starts driving at 10 m/s. In such a scenario, as illustrated in the graph of FIG. 3C, vehicle 330b arrives at the intersection sooner and, in this case, may collide with vehicle 330c. In order for vehicle 330c to avoid a collision, an intersection controller such as described herein (e.g., intersection controller 101) may be operable to modify the velocity of vehicle 330c (by instructing the vehicle to open the throttle to speed up) and clear the intersection before vehicle 330b arrives. The intersection controller could further be operable to instruct vehicle 330c to control its speed such that it didn't increase beyond some specified threshold and thus vehicle 330c avoided colliding with vehicle 330a. As an alternative, intersection controller 101 may determine, via the logic and methodologies described herein, to instruct vehicle 330c to drive slower and arrive at the intersection after vehicle 330b cleared intersection 350, thus also avoiding a collision with vehicle 330a.

In an embodiment, an initially intended or expected route of a vehicle approaching an intersection is known to, determined or assumed by the intersection controller on-board controllers of the vehicle. In some embodiments, the route and/or expected destination of vehicle 330c may be unpredictable and/or unknown (e.g., it is an unconnected vehicle, or another type of moving element such as a pedestrian). In these embodiments, the controller may utilize historical data to compute a probability density function and/or a probability curve of possible and/or likely routes for the unknown element 330c as depicted in FIG. 3E. In an embodiment, in the A-B-C x-time plot as depicted in FIG. 3C, the box denoting elements 330c may grow upwardly showing a likelihood of being in the intersection at a larger span of time t, while simultaneously growing to the left and/or right denoting a likelihood that the element 330c could cross the intersection at a larger span of the distance along the road A-B-C as computed using the probability curve 358 from FIG. 3E. As vehicle 330b approaches the intersection 350, the precision (i.e., the tightness of the curve 358) of the probability density function is constantly (e.g., at about 10-100 Hz) updated and the accuracy improved such that the expanded window is small enough to allow vehicle 330b to find an efficient solution through the intersection 350.

Referring now to FIG. 3D, illustrated therein is a graph of the anticipated motion of the three vehicles 330a-c illustrated in FIG. 3A over time from the perspective of vehicle 330c and in which example different possible paths for vehicle 330c are illustrated. If one plots the road that vehicle 330c is driving on, D through B to E, then 330a-b only show up when they cross through the intersection 350. In this case, the initial route 330c-1 of vehicle 330c crosses the intersection between vehicle 330a-b. Alternatively, vehicle 350c can wait two seconds before moving, and pass through the intersection 350 after vehicle 330b clears as shown by route 330c-2. Vehicle 330c could alternatively start driving immediately, but drive slower, as shown by route 330c-3. The route 330c-3 is shown thicker because the vehicle 330c is moving slower, therefore spending more time (y-direction) at each discrete location. There are many more alternatives for vehicles 330a-c. Such possible alternate paths could be plotted and considered by a controller for the intersection. In one embodiment, the controller may be operable to select a set of paths, one path for each vehicle, that is best or considered to be optimal based on the parameters or considerations that the controller is programmed to consider and weigh. For example, what is “best” could depend on considerations such as fuel efficiency, traffic throughput, commute time, vehicle capabilities, vehicle priority, etc.

Applicant recognizes that there are several ways to implement a smart intersection controller (referred to as a “controller” herein) as described herein; a controller can utilize different methods to manage vehicle traffic through an intersection by identifying how each vehicle should proceed through an intersection (e.g., by selecting paths, speeds, trajectories, etc. and instructing the vehicles accordingly). One example method is an x-y-time graph search. In such a method, time and space are divided into small grids cells, or nodes. A vehicle can transition from one node to nearby nodes. From each of those nodes, it can transition to yet other nearby nodes. Which node a vehicle can transition to are limited by vehicle maximum speed, maximum acceleration, maximum braking, and that time always moves up.

Referring now to FIG. 3F, an example of how a vehicle can transition from one node to another is illustrated. In the example, a vehicle can transition from node N1 to 4 other cells. In this example, it may be assumed that the vehicle is not permitted to drive in reverse. Many possible paths can be computed. One path, P1, depicts how a vehicle may accelerate from being stopped, for example, up to the limit of the vehicle or the particular motorway the vehicle is driving upon. As an example, Route 330c-2 in FIG. 3D shows the speed instantaneously going from 0 to 10 m/s for simplicity, although it should be known that this is neither possible nor advisable to change speeds so quickly. Accelerating so quickly may disturb any cargo on board the vehicle 330c, and/or may be uncomfortable for any passengers within vehicle 330c. FIG. 3F depicts how the vehicle 330c may accelerate from one node to another using small speed variations to increase fuel efficiency and reduce passenger and cargo disturbances. The space between the nodes may be very small with respect to the distances traveled such that the forces on the passengers and/or on-board cargo are minimized while still achieving the separation necessary within the intersection. For example, the acceleration or change in speed may be managed such that a passenger does not experience G-forces outside of a range of 1.5 g-3 g, and preferably about 2.0 g.

In accordance with some embodiments, for each path, required speeds, accelerations, decelerations can be computed and used to estimate fuel efficiency, travel time, etc. These and other parameters can be used to rank the different alternative set of paths. This method is expanded into the x-y-time. It should be noted that while vehicle is in one cell, it occupies more than one cell.

Referring now to FIG. 3G, the method described above with reference to FIG. 3F, for the x-time graph search, is expanded to an x-y-time graph search that includes all vehicles. In a similar manor, the x-y-time space is divided into nodes. Each vehicle 330a-c moves from one node to another, with time t shown on the z-scale. This creates a large number of potential path sets where each set contains one path per vehicle.

In accordance with some embodiments, for each path or route of vehicles 330a-c, required speeds, accelerations, and decelerations can be computed and used to estimate fuel efficiency, travel time, etc. Each set of routes are analyzed to detect potential collisions, or how closely the vehicles 330a-c will pass each other. These and other parameters can be used to rank the different alternative set of routes and select the best set. Directed search methods such as A* can be used to reduce search time. In the example of FIG. 3G, one alternative set of paths for the three vehicles is plotted in x-y-time. In this example, vehicle 330c crosses the intersection 350 between vehicles 330a and 330b.

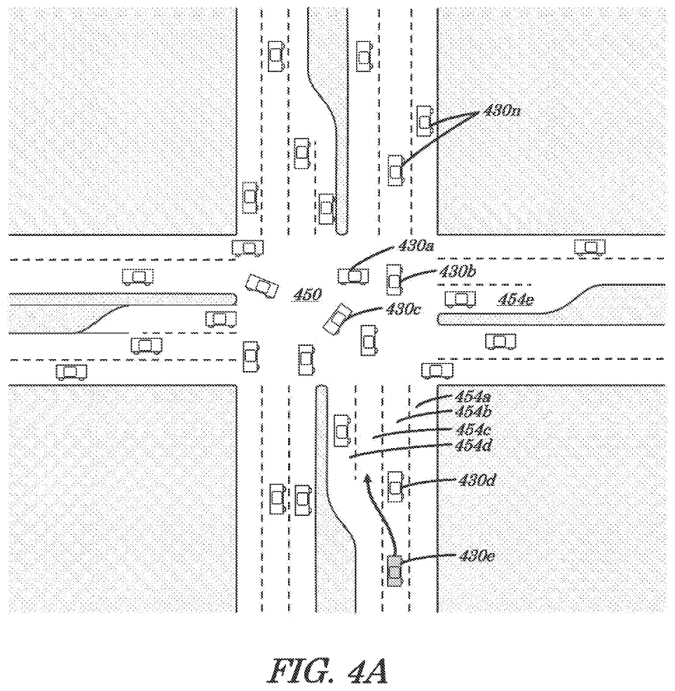

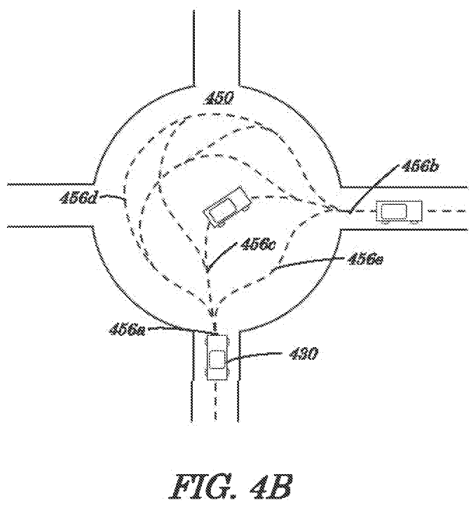

In some embodiments, as depicted in FIG. 4A and FIG. 4B, many intersections 450 are more complicated and may contain multiple lanes 454 in each direction or no lanes at all. According to some embodiments, an automatic intersection control system, for example, may comprise an automatic intersection control system 100 of FIG. 1 including a controller (not shown in FIG. 4A or FIG. 4B) or a plurality of controllers associated with each vehicle 430 herein. Each vehicle 430a-n may cross several lanes of cross traffic while traversing the intersection 450, while never having to come to a complete stop (e.g., keeping the speed component of velocity greater than zero). Potential collisions in each lane 454 within the intersection 450 must be avoided, similar to the single cross lane example in FIG. 4. As an example, as a vehicle 430 traverses the intersection 450 (e.g., vehicle 430a traveling east to west in FIG. 4A), the vehicle 430 blocks each lane 454 of a cross-road at a different time t. In the non-limiting example of vehicle 430a, the first lane 454a is blocked first, then the second lane 454b and then the third 454c. At some point in time, the vehicle has moved forward enough that it is no longer blocking the first lane 454a. The lane 454a becomes unblocked to cross-traffic, and then the second lane 454b, and so on. A vehicle 430b may enter the intersection even though cross traffic may still be blocking one or more lanes 454 and the vehicle 430a may not have completely cleared the intersection 450 before cross traffic (e.g., vehicle 430b traveling south to north) enters the lanes 454 that vehicle 430a has cleared. The size of the vehicle and the size of its safety buffer (e.g., a vehicle carrying precious or dangerous cargo may require a larger buffer than other more typical vehicles) affect when a cross lane 454 is considered blocked by the system. Similarly, as a vehicle 430c is turning left from a left turn lane 454e (e.g., turning southward from a westbound lane), the vehicle 430b may advance into the intersection 450 before the vehicle 430b has fully exited the intersection 450.

In another embodiment, in order to more efficiently move vehicles 430 through the intersection, a vehicle 430e (e.g., a northbound vehicle in the middle lane) that is following a vehicle 430d (e.g., another northbound vehicle in the middle lane) may increase speed and change lanes from, for example, lane 454b to lane 454c such that the vehicles 430d-e pass through the intersection 450 at the same time side-by-side. The arrows depicting this on FIG. 4A are for illustrative purposes only, as the controller may predict this well in advance of the vehicles 430d-e reaching the intersection and smoothly and/or gradually change the speed and/or the lane 454 of at least one or both of vehicles 430d-e over a longer distance and far before reaching the intersection 450 to more efficiently allow them through intersection 450 to minimize the perceived acceleration (e.g., to maximize the comfort level of on-board passengers) on any cargo and/or passengers within and minimize the fuel consumed (e.g., by reducing brake usage and/or reducing the amount of time a vehicle is accelerating back up to normal speed) by the vehicles 430d-e. In an embodiment, the gradual acceleration and deceleration within the vehicle should not exceed about 0.1 G in any direction (e.g., the passengers and cargo may be managed such that they do not experience G-forces outside of about 0.9-1.1 total G forces during the acceleration and deceleration or between 1.5 and 3.0 G forces, and no more than 0.1 G in the lateral direction during turning and/or route changes) such that the comfort of the passengers is maximized and/or the jostling of any on-board cargo is minimized (e.g., to keep cargo from tipping over, and/or contacting other items of cargo).

In some embodiments as depicted in FIG. 4B, there may be no lanes 454 through the intersection 450 at all. The initial route 456 of the vehicle 430 may include an entrance 456a and a destination 456b from the intersection 450, but the route 456 to get to the destination 456b may take any path through the intersection 450 that the traffic within the intersection 450 allows. In some embodiments, the controller may route the vehicle 430 on a very simple path 456c that allows the vehicle 430 to decelerate and accelerate the least, minimizing the acceleration felt inside the vehicle 430 on passengers and/or cargo. In some embodiments, the controller may route the vehicle 430 on a path 456d around the intersection to keep all traffic within the intersection 450 moving and not slowing down. In still other embodiments, the controller may route the vehicle 430 on the shortest path 456e to minimize the space or nodes occupied by the vehicle 430 within the intersection in total (e.g., to keep the vehicle out of the path of an emergency vehicle or other vehicle with a higher priority than vehicle 430 through the intersection).

While an intersection 450 is shown in FIG. 4B, in still other embodiments similar path finding or functionality may be accomplished in another type of area or open space (e.g., a parking lot, a truck yard, and/or any other space with multiple automatically controlled vehicles finding a path from a starting point to destination) using the same considerations. In some embodiments, the entrance 456a may be a gate leading into a truck yard with multiple trucks or yard hostlers ferrying trailers (not specifically depicted in FIG. 4B) from long-haul tractors to a destination (e.g., a particular dock that a trailer need to get to in order to load and/or unload cargo). The yard hostlers 430 may take the trailer from the entrance 456a to a dock 456b while maneuvering through the truck yard 450. The controller may route the yard hostler 430 in the most efficient path from the entrance 456a to the dock 456b while avoiding collisions with other yard hostlers 430 within the truck yard 450 in a manner consistent with the embodiments disclosed herein.

In still other embodiments, the intersection 450 may be a parking lot, whereby the entrance 456a is the entrance to the parking lot or a valet station and the destination is an open parking space 456b. The controller may compute the most efficient path from the entrance 456a to the parking space 456b while avoiding collisions with other vehicles 430 that are moving to a parking space 456b in a manner consistent with the embodiments disclosed herein.

In some embodiments, the planning or managing by a controller for a complicated intersection (e.g., as shown in FIG. 4A) or large open space (e.g., as shown in FIG. 4B) is fundamentally the same as the simple intersection, like that depicted in FIG. 3A. The intersection is expanded to an x-y-time graph and divided into nodes. Sets of potential paths in x-y-time are computed and analyzed to detect collisions, or how close the vehicle get to each other. These and other parameters can be used to rank the different alternative set of paths and select the best set. Directed search methods may be used in some embodiments to reduce search time.

It should be noted that a controller as described herein could be utilized to identify and instruct paths for vehicles for purposes other than traversing an intersection safely or to avoid collisions with other vehicles. For example, a controller as described herein could be utilized to direct a vehicle to clear an obstacle or obstruction in a roadway, such as by directing a snow plow vehicle on a path to take to plow a snow berm in the road. For example, sensors associated with the detector may be operable to detect the berm (e.g., through optical recognition) and the controller can compute a path for a snow plow to take to clear the berm.

It should further be noted that although some of the embodiments described herein have described a single controller at an intersection, there may be multiple controllers (operating in cooperation, serially or in parallel) for a given intersection. In some embodiments, controllers may be located at a distance prior to an intersection. In some embodiments, various detecting components that are operable to communicate with a controller may be located near the intersection (e.g., cameras, pressure sensors, microphones, motion sensors, etc.). Some of such detecting components may be operable to communicate with passing vehicles (e.g., to read or obtain data regarding a given vehicle approaching an intersection and pass this data to a controller of the intersection). In some embodiments, a controller may comprise a component of one or more of the vehicles traversing an intersection and may be operable to communicate with other controllers of other vehicles traversing the intersection (e.g., a decentralized version of some of the embodiments described herein). For example, in one embodiment, a controller of a given vehicle may be operable to communicate with and/or determine data of other vehicles that are within a certain distance (e.g., within 0.25 miles) of itself or within a certain distance of an intersection the vehicle is approaching.

### III. Computing Device in Use With the Intersection Control Systems

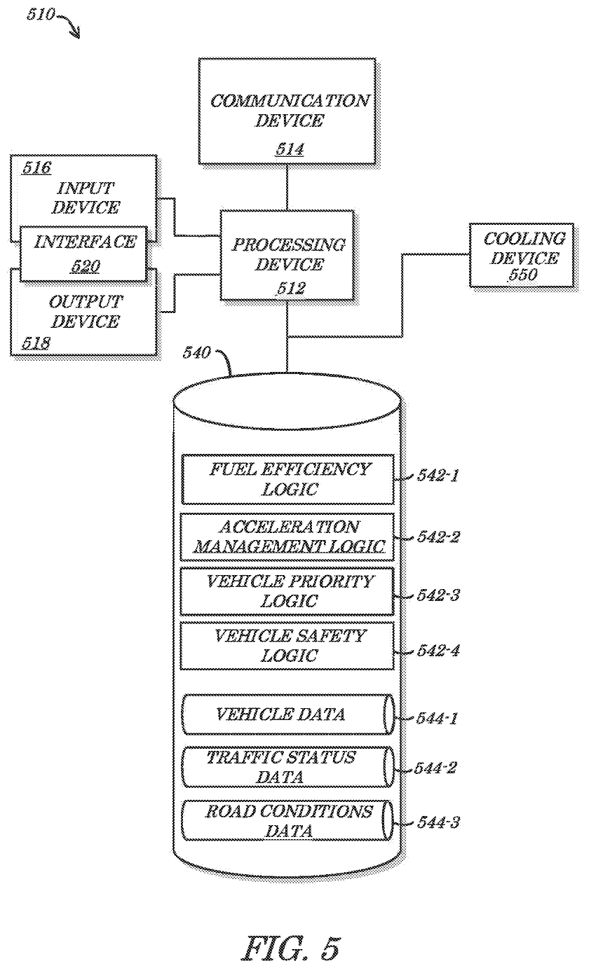

Turning to FIG. 5, a block diagram of a controller 510 according to some embodiments is shown. In some embodiments, the controller 510 may be similar in configuration and/or functionality to one or more of the intersection control systems 100 of FIG. 1, FIG. 2A-FIG. 2B, FIG. 3A-FIG. 3G, and/or FIG. 4A-FIG. 4B herein. In some embodiments, the controller 510 may comprise a processing device 512, a communication device 514, an input device 516, an output device 518, an interface 520, a memory device 540 (storing various programs and/or instructions 542 and data 544), and/or a cooling device 550. According to some embodiments, any or all of the components 512, 514, 516, 518, 520, 540, 542, 544, 550 of the controller 510 may be similar in configuration and/or functionality to any similarly named and/or numbered components described herein. Fewer or more components 512, 514, 516, 518, 520, 540, 542, 544, 550 and/or various configurations of the components 512, 514, 516, 518, 520, 540, 542, 544, 550 may be included in the controller 510 without deviating from the scope of embodiments described herein.

According to some embodiments, the processor 512 may be or include any type, quantity, and/or configuration of processor that is or becomes known. The processor 512 may comprise, for example, an Intel® IXP 2800 network processor or an Intel® XEON™ Processor coupled with an Intel® E7501 chipset. In some embodiments, the processor 512 may comprise multiple interconnected processors, microprocessors, and/or micro-engines. According to some embodiments, the processor 512 (and/or the controller 510 and/or other components thereof) may be supplied power via a power supply (not shown), such as a battery, an Alternating Current (AC) source, a Direct Current (DC) source, an AC/DC adapter, solar cells, and/or an inertial generator. In the case that the controller 510 comprises a server, such as a blade server, necessary power may be supplied via a standard AC outlet, power strip, surge protector, and/or Uninterruptible Power Supply (UPS) device.

In some embodiments, the communication device 514 may comprise any type or configuration of communication device that is or becomes known or practicable. The communication device 514 may, for example, comprise a Network Interface Card (NIC), a telephonic device, a cellular network device, a router, a hub, a modem, and/or a communications port or cable. In some embodiments, the communication device 514 may be coupled to receive user input data, e.g., from a user device (not shown in FIG. 5). The communication device 514 may, for example, comprise a Bluetooth® Low Energy (BLE) and/or RF receiver device and/or a camera or other imaging device that acquires data from a user (not separately depicted in FIG. 5) and/or a transmitter device that provides the data to a remote server and/or server or communications layer (also not separately shown in FIG. 5). According to some embodiments, the communication device 514 may also or alternatively be coupled to the processor 512. In some embodiments, the communication device 514 may comprise an infrared (IR), RF, Bluetooth™, Near-Field Communication (NFC), and/or Wi-Fi® network device coupled to facilitate communications between the processor 512 and another device (such as a remote user device, not separately shown in FIG. 5).

In some embodiments, the input device 516 and/or the output device 518 are communicatively coupled to the processor 512 (e.g., via wired and/or wireless connections and/or pathways) and they may generally comprise any types or configurations of input and output components and/or devices that are or become known, respectively. The input device 516 may comprise, for example, a keyboard that allows an operator of the controller 510 to interface with the controller 510 (e.g., by an operator to update a traffic condition, as described herein). In some embodiments, the input device 516 may comprise a sensor, such as an imaging, ultrasonic, radar, lidar, and/or other input device and report measured values via signals to the controller 510 and/or the processor 512. The output device 518 may, according to some embodiments, comprise a display screen and/or other practicable output component and/or device. The output device 518 may, for example, provide an interface (such as the interface 520) via which traffic and/or vehicle priority parameters may be output to a user. According to some embodiments, the input device 516 and/or the output device 518 may comprise and/or be embodied in a single device, such as a touch-screen monitor or a personal handheld device.

The memory device 540 may comprise any appropriate information storage device that is or becomes known or available, including but not limited to, units and/or combinations of magnetic storage devices (e.g., a hard disk drive), optical storage devices, and/or semiconductor memory devices, such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 540 may, according to some embodiments, store one or more of fuel efficiency logic 542-1, acceleration management logic 542-2, vehicle priority logic 542-3, vehicle safety logic 542-4, vehicle data 544-1, traffic status data 544-2, and/or road conditions data 544-3. In some embodiments, the fuel efficiency logic 542-1, acceleration management logic 542-2, vehicle priority logic 542-3, vehicle safety logic 542-4, vehicle data 544-1, traffic status data 544-2, and/or road conditions data 544-3 may be utilized by the processor 512 to analyze input received from the input device 516 and provide intersection traverse instructions, and/or other system information via the output device 518 and/or the communication device 514.

According to some embodiments, the fuel efficiency logic 542-1 may be operable to cause the processor 512 to process the vehicle data 544-1, traffic status data 544-2, and/or road conditions data 544-3 in accordance with embodiments as described herein. Vehicle data 544-1, traffic status data 544-2, and/or road conditions data 544-3 received via the input device 516 and/or the communication device 514 may, for example, be analyzed, sorted, filtered, decoded, decompressed, ranked, scored, plotted, and/or otherwise processed by the processor 512 in accordance with the fuel efficiency logic 542-1. In some embodiments, vehicle data 544-1, traffic status data 544-2, and/or road conditions data 544-3 may be fed by the processor 512 through one or more mathematical and/or statistical formulas and/or models in accordance with the fuel efficiency logic 542-1 to process input data to route a vehicle or a plurality of vehicles through an intersection and/or other space in the most fuel efficient manner, in accordance with embodiments described herein.

In some embodiments, the acceleration management logic 542-2 may be operable to cause the processor 512 to process the vehicle data 544-1, traffic status data 544-2, and/or road conditions data 544-3 in accordance with embodiments as described herein. Vehicle data 544-1, traffic status data 544-2, and/or road conditions data 544-3 received via the input device 516 and/or the communication device 514 may, for example, be analyzed, sorted, filtered, decoded, decompressed, ranked, scored, plotted, and/or otherwise processed by the processor 512 in accordance with the acceleration management logic 542-2. In some embodiments, vehicle data 544-1, traffic status data 544-2, and/or road conditions data 544-3 may be fed by the processor 512 through one or more mathematical and/or statistical formulas and/or models in accordance with the acceleration management logic 542-2 to route a vehicle or a plurality of vehicles through an intersection and/or other space with the least amount of acceleration felt by the cargo and/or on-board passengers, in accordance with embodiments described herein.

According to some embodiments, the vehicle priority logic 542-3 may be operable to cause the processor 512 to process the vehicle data 544-1, traffic status data 544-2, and/or road conditions data 544-3 in accordance with embodiments as described herein. Vehicle data 544-1, traffic status data 544-2, and/or road conditions data 544-3 received via the input device 516 and/or the communication device 514 may, for example, be analyzed, sorted, filtered, decoded, decompressed, ranked, scored, plotted, and/or otherwise processed by the processor 512 in accordance with the vehicle priority logic 542-3. In some embodiments, vehicle data 544-1, traffic status data 544-2, and/or road conditions data 544-3 may be fed by the processor 512 through one or more mathematical and/or statistical formulas and/or models in accordance with the vehicle priority logic 542-3 to prioritize the route or routes of a vehicle or a plurality of vehicles such that the highest priority vehicle or vehicles (e.g., emergency vehicles) move through the intersection as quickly as possible, in accordance with embodiments described herein.

According to some embodiments, the vehicle safety logic 542-4 may be operable to cause the processor 512 to process the vehicle data 544-1, traffic status data 544-2, and/or road conditions data 544-3 in accordance with embodiments as described herein. Vehicle data 544-1, traffic status data 544-2, and/or road conditions data 544-3 received via the input device 516 and/or the communication device 514 may, for example, be analyzed, sorted, filtered, decoded, decompressed, ranked, scored, plotted, and/or otherwise processed by the processor 512 in accordance with the vehicle safety logic 542-4. In some embodiments, vehicle data 544-1, traffic status data 544-2, and/or road conditions data 544-3 may be fed by the processor 512 through one or more mathematical and/or statistical formulas and/or models in accordance with the vehicle safety logic 542-4 to generate and/or communicate a factor of safety required for each vehicle traversing the intersection and/or other open space and adjust the allowable space between crossing vehicles, in accordance with embodiments described herein.

According to some embodiments, the controller 510 may comprise the cooling device 550. According to some embodiments, the cooling device 550 may be coupled (physically, thermally, and/or electrically) to the processor 512 and/or to the memory device 540. The cooling device 550 may, for example, comprise a fan, heat sink, heat pipe, radiator, cold plate, and/or other cooling component or device or combinations thereof, configured to remove heat from portions or components of the controller 510.

Any or all of the exemplary instructions and data types described herein and other practicable types of data may be stored in any number, type, and/or configuration of memory devices that is or becomes known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the controller 510. According to some embodiments, the memory device 540 may be incorporated into and/or otherwise coupled to the controller 510 (e.g., as shown) or may simply be accessible to the controller 510 (e.g., externally located and/or situated).

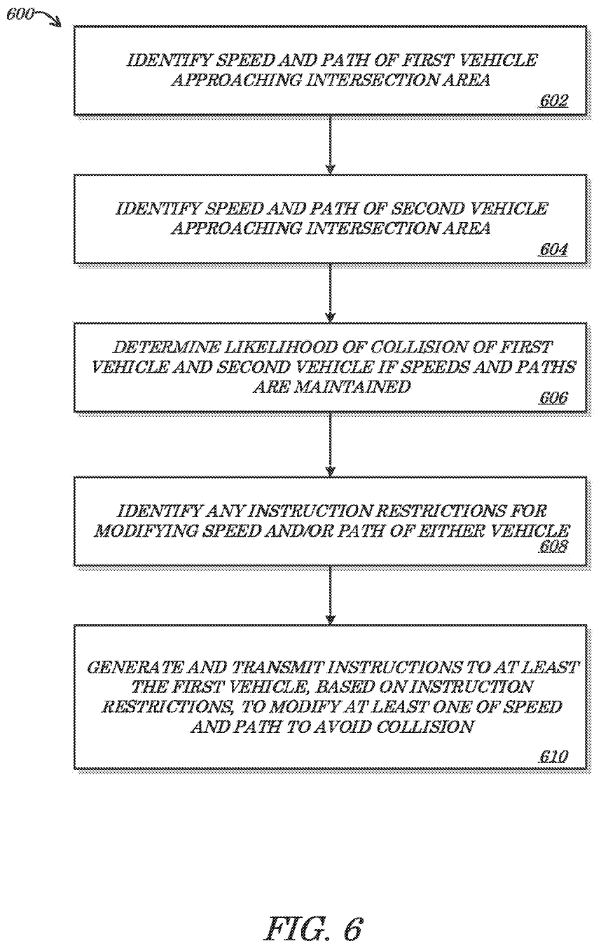

Referring now to FIG. 6, a flow diagram of a method 600 according to some embodiments are shown. In some embodiments, the method 600 may be performed and/or implemented by and/or otherwise associated with one or more specialized and/or specially-programmed computers (e.g., one or more of the intersection controller 101, computing device 110, the remote server 106 of FIG. 1 and/or the apparatus 510 of FIG. 5), computer terminals, computer servers, computer systems and/or networks, and/or any combinations thereof (e.g., by one or more multi-threaded and/or multi-core processing units of a selective GNSS/GPS navigation system).

The flow diagram described herein with reference to FIG. 6 does not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the memory/data storage devices 140 of FIG. 1 and/or the memory/storage device 540 of FIG. 5 herein) may store thereon instructions that when executed by a machine (such as a computerized processor) result in performance according to any one or more of the embodiments described herein.

In some embodiments, the method 600 may comprise receiving, determining or identifying (e.g., from one or more remote transmitters and/or via at least one antenna) data comprising a speed and/or anticipated path of a first vehicle approaching an intersection being managed by an intersection controller (e.g., an intersection controller 101 or 510), at 602. This data may be received, for example, from sensor 102 and/or vehicle 130 (referring to example components of system 100 of FIG. 1). In some embodiments, the data may be computed based on information accessible to the device performing the method 600 (e.g., an anticipated path for a vehicle may be determined based on the current location and velocity of the vehicle and some of the other considerations described with reference to FIG. 5).

In some embodiments, the method 600 may comprise receiving, determining or identifying (e.g., from one or more remote transmitters and/or via at least one antenna) data comprising a speed and/or anticipated path of a second vehicle approaching an intersection being managed by an intersection controller (e.g., an intersection controller 101 or 510), at 604. This data may be received, for example, from sensor 102 and/or a second vehicle 130 (referring to example components of system 100 of FIG. 1). In some embodiments, the data may be computed based on information accessible to the device performing the method 600 (e.g., an anticipated path for a vehicle may be determined based on the current location and velocity of the vehicle and some of the other considerations described with reference to FIG. 5).

In some embodiments, the intersection controller may compare the anticipated path of the first vehicle and the anticipated path of the second vehicle and compute a location that the anticipated path of the first vehicle and the anticipated path of the second vehicle intersect (e.g., by overlaying the paths of the first and second vehicles and determining a point or a node that both paths include), at 606. The intersection controller may then compute a time at which each vehicle will be at the intersection of the anticipated paths of the first and second vehicle (e.g., a probability curve including any error in the sensor and/or the controls of each vehicle) and determine a likelihood of a collision between the first and second vehicle.

In some embodiments, the controller will cross-reference a safety probability margin for each vehicle and add that safety probability margin to each probability curve of time at the intersection of the anticipated paths of the first and second vehicles. If the probability curves of the times that the first and second vehicles will be at the intersection of the anticipated paths of the first and second vehicles overlaps and/or is within the predetermined safety probability margin, remedial measures may need to be taken. The controller may then review the intersection for any instruction restrictions (e.g., a lane is unusable because of an obstruction, construction, large potholes, or any other obstruction sensed by the sensor and communicated to the intersection controller) that may affect any potential adjustment of the speed or the path for the first vehicle and/or the second vehicle and restrict that option from its analysis, at 608.

In some embodiments, possible speed and path changes for both the first and second vehicles are analyzed by the intersection controller and the most efficient solution is generated in accordance with the embodiments disclosed herein, at 610. A signal then may be sent from the intersection controller to the first vehicle to change its speed (e.g., speed up or slow down such that the first vehicle arrives at the intersection of the anticipated paths of the first and second vehicles at a different time than what was previously computed at 602 to avoid a collision and/or is outside of the predetermined safety margin for the first vehicle and/or the second vehicle), and/or change its path (e.g., change lanes and/or take another route by different roads such that the paths of the first vehicle and second vehicle do not cross or the first and second vehicles will arrive at the updated anticipated intersection of the paths of the first vehicle and the second vehicle at sufficiently separated times) in accordance with embodiments described herein.

### IV. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The present disclosure is widely applicable to numerous embodiments, as is readily apparent from the disclosure. One of ordinary skill in the art will recognize that the disclosure may be practiced with various modifications and alterations, such as structural, logical, software, and electrical modifications. Although particular features of the disclosure may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present disclosure. Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the disclosure, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like. The term “computing” as utilized herein may generally refer to any number, sequence, and/or type of electronic processing activities performed by an electronic device, such as, but not limited to looking up (e.g., accessing a lookup table or array), calculating (e.g., utilizing multiple numeric values in accordance with a mathematic formula), deriving, and/or defining.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present disclosure can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the disclosure as defined by the claims appended hereto.

What is claimed is:

1. A system for optimizing paths of ground vehicles through an intersection, the system comprising:
a sensor operable to detect first data corresponding to a first ground vehicle approaching an intersection and second data corresponding to a second ground vehicle approaching the intersection, the intersection comprising a first area;
a wireless communication device operable to communicate with at least the first ground vehicle;
an actuator operatively connected to a throttle of the first ground vehicle and a steering element of the first ground vehicle; and
a controller operable to communicate with the sensor, the actuator, and the wireless communication device, the controller configured to:
(i) identify, based on the first data, a first speed at which the first ground vehicle is currently traveling and a first path the first ground vehicle is anticipated to travel towards the first area;
(ii) identify, based on the second data, a second speed at which the second ground vehicle is currently traveling and a second path the second ground vehicle is anticipated to travel towards the first area;
(iii) compute a first time at which the first ground vehicle is anticipated to arrive within the first area if it were to continue to travel at the first speed and along the first path;
(iv) compute a second time at which the second ground vehicle is anticipated to arrive within the first area if it were to continue to travel at the second speed and along the second path;
(v) determine that the first time and the second time are sufficiently close that a collision between the first ground vehicle and the second ground vehicle has a probability higher than a predetermined safety probability to occur;
(vi) identify at least one of (a) a first physical obstacle between the first ground vehicle and the first area, (b) a second physical obstacle between the second ground vehicle and the first area, and (c) a lack of ability to electronically communicate with the second ground vehicle, thereby identifying an instruction restriction;
(vii) generate, based on the instruction restriction, a first instruction for the first ground vehicle, the first instruction directing the first ground vehicle to adjust at least one of the first speed and the first path such that the first ground vehicle is anticipated to arrive within the area at a third time, the third time being sufficiently different from the second time that a probability of a collision between the first ground vehicle and the second ground vehicle is lower than the predetermined safety probability; and
(viii) transmit, via the wireless communication device, the first instruction to the first ground vehicle, the first instruction causing the actuator of the first ground vehicle to adjust at least one of the first speed to a third speed and the first path to a third path.

2. The system of claim 1, wherein the first instruction instructs the first ground vehicle to gradually adjust its acceleration from at least one of the first speed to the third speed and the first path to the third path in a manner that is optimized based on a comfort level of any on-board passengers.

3. The system of claim 1, wherein the manner being optimized based on a comfort level of any on-board passengers comprises adjusting the acceleration such that acceleration remains between 1.5 g and 3 g.

4. The system of claim 1, wherein the third speed of the first ground vehicle is greater than zero.

5. The system of claim 1, wherein the controller is further configured to transmit a second instruction to the first ground vehicle, the second instruction directing the first ground vehicle to change its speed to a fourth speed after traversing the intersection, and wherein the fourth speed is the same as the first speed.

6. The system of claim 1, wherein the controller is further configured to transmit a second instruction to the second ground vehicle, the second instruction directing the second ground vehicle to change its speed from the second speed to a fourth speed.

7. The system of claim 6, wherein the fourth speed of the second ground vehicle is greater than zero.

8. The system of claim 6, wherein the sensor is further configured to detect third data corresponding to a third vehicle approaching the intersection, the third data comprising at least one of a location, a speed, and a path of the third vehicle and wherein at least one of the first instruction and the second instruction is generated based on a probability density function of expected destinations for the third vehicle.

9. The system of claim 8, further comprising a traffic light in communication with and controlled by the controller and in view of at least the third vehicle, wherein the controller is further configured to at least partially reduce a number of options made available to the third vehicle by the traffic light in order to improve a precision of the probability density function.

10. The system of claim 8, wherein the controller is further operable to include a predetermined safety margin in at least one of the first instruction and the second instruction to account for unpredictable activity by the third vehicle.

11. The system of claim 6, wherein the sensor is further configured to detect fourth data corresponding to at a pedestrian in the vicinity of the intersection, the fourth data comprising at least one of a location, a speed, and a path of the pedestrian, and wherein at least one of the first instruction and the second instruction is based on a probability curve of expected destination for the pedestrian.

12. The system of claim 11, further comprising a pedestrian crossing light in communication with and controlled by the controller and in view of the pedestrian, wherein the controller is further configured to at least partially reduce the options made available to the pedestrian by the pedestrian crossing light in order to improve a precision of the probability density function.

13. The system of claim 1, wherein the controller is further operable to prioritize a traversal of the intersection by an emergency vehicle approaching the intersection by:
receiving from the sensor an indication of third data corresponding to a third vehicle approaching the intersection, the third data comprising a location, a speed, a path, and destination of the third vehicle;
identifying the third vehicle as an emergency vehicle;
assigning a priority to the third vehicle, such that the first instruction causes the first ground vehicle rather than the third vehicle to adjust its speed in traversing the intersection.

14. The system of claim 1, wherein the sensor is further operable to sense an obstruction along the first path of the first ground vehicle, and the controller is further operable to generate the first instruction by computing a fourth path for the first ground vehicle that allows the first ground vehicle to avoid the obstruction, the first instruction comprising the fourth path.

15. A method performed by a computing device, for optimizing a traversal of an intersection by multiple ground vehicles, the method comprising:
receiving, from at least one of a first ground vehicle approaching a first area monitored by the computing device and a sensor corresponding to the computing device, first data corresponding to the first ground vehicle;
receiving, from at least one of a second ground vehicle approaching the intersection and the sensor, second data corresponding to the second ground vehicle;
identifying, by the computing device and based on the first data, a first speed at which the first ground vehicle is currently traveling and a first path the first ground vehicle is anticipated to travel towards the first area;
identifying, based on the second data, a second speed at which the second ground vehicle is currently traveling and a second path the second ground vehicle is anticipated to travel towards the first area;
computing a first time at which the first ground vehicle is anticipated to arrive within the first area if it were to continue to travel at the first speed and along the first path;
computing a second time at which the second ground vehicle is anticipated to arrive within the first area if it were to continue to travel at the second speed and along the second path;
determining that the first time and the second time are sufficiently close that a collision between the first ground vehicle and the second ground vehicle has a probability higher than a predetermined safety probability to occur;
identifying at least one of (a) a first physical obstacle between the first ground vehicle and the first area, (b) a second physical obstacle between the second ground vehicle and the first area, and (c) a lack of ability to electronically communicate with the second ground vehicle, thereby identifying an instruction restriction;
generating, based on the instruction restriction, a first instruction for the first ground vehicle, the first instruction directing the first ground vehicle to adjust at least one of the first speed and the first path such that the first ground vehicle is anticipated to arrive within the area at a third time, the third time being sufficiently different from the second time that a probability of a collision between the first ground vehicle and the second ground vehicle is lower than the predetermined safety probability; and
transmitting, via a wireless communication device, the first instruction to the first ground vehicle, the first instructing for directing an actuator of the first ground vehicle to adjust at least one of the first speed to a third speed and the first path to a third path in accordance with the first instruction.

16. The method of claim 15, wherein the first instruction instructs the first ground vehicle to gradually adjust its acceleration from at least one of the first speed to the third speed and the first path to the third path in a manner that is optimized based on a comfort level of any on-board passengers.

17. The method of claim 15, wherein the manner being optimized based on a comfort level of any on-board passengers comprises adjusting the acceleration such that acceleration remains between 1.5 g and 3 g.

18. The method of claim 15, wherein the third speed of the first ground vehicle is greater than zero.

19. The method of claim 15, further comprising transmitting a second instruction to the first ground vehicle, the second instruction directing the first ground vehicle to change its speed to a fourth speed after traversing the intersection, and wherein the fourth speed is the same as the first speed.

20. The method of claim 15, further comprising transmitting a second instruction to the second ground vehicle, the second instruction directing the second ground vehicle to change its speed from the second speed to a fourth speed.

21. The method of claim 20, wherein the fourth speed of the second ground vehicle is greater than zero.

22. The method of claim 20, further comprising:
receiving, from at least one of a third vehicle approaching the intersection and the sensor, third data corresponding to the third vehicle, the third data comprising at least one of a location, a speed, and a path of the third vehicle, and
wherein at least one of the first instruction and the second instruction is generated based on a probability density function of expected destinations for the third vehicle.

23. The method of claim 20, further comprising:
communicating with a traffic light corresponding to the first area and that is in view of at least the third vehicle in order to at least partially reduce a number of options made available to the third vehicle by the traffic light, in order to improve a precision of the probability density function.

24. The method of claim 20, further comprising:
including a predetermined safety margin in at least one of the first instruction and the second instruction to account for unpredictable activity by the third vehicle.

25. The method of claim 20, further comprising:
receiving, from the sensor, fourth data corresponding to at a pedestrian in the vicinity of the first area, the fourth data comprising at least one of a location, a speed, and a path of the pedestrian, and
wherein at least one of the first instruction and the second instruction is based on a probability curve of expected destination for the pedestrian.

26. The method of claim 25, further comprising:
communicating with a pedestrian crossing light corresponding to the first area and in view of the pedestrian, to at least partially reduce the options made available to the pedestrian by the pedestrian crossing light in order to improve a precision of the probability density function.

27. The method of claim 15, further comprising:
prioritizing a traversal of the first area by an emergency vehicle approaching the first area by:
receiving from the sensor an indication of third data corresponding to a third vehicle approaching the first area, the third data comprising a location, a speed, a path, and destination of the third vehicle;
identifying the third vehicle as an emergency vehicle;
assigning a priority to the third vehicle, such that the first instruction causes the first ground vehicle rather than the third vehicle to adjust its speed in traversing the first area.

28. The method of claim 15, further comprising:
sensing an obstruction along the first path of the first ground vehicle, and
wherein generating the first instruction comprises generating the first instruction by computing a fourth path for the first ground vehicle that allows the first ground vehicle to avoid the obstruction, the first instruction comprising the fourth path.

29. A system for optimizing paths of ground vehicles through an intersection, the system comprising:
a sensor on a first vehicle in communication with a second vehicle for communicating a location, a velocity, a priority, and a route of the second vehicle;
an actuator on the first vehicle operably connected to a throttle and a steering apparatus of the first vehicle;
a controller on the first vehicle in electrical communication with the actuator and the sensor on the first vehicle, the controller on the first vehicle configured to compute a location and a time that a route of the first vehicle and the route of the second vehicle intersect and to control a speed and a direction of the first vehicle;
a sensor on the second vehicle in communication with the first vehicle for communicating a location, a velocity, a priority, and the route of the first vehicle; and
a controller on the second vehicle in electrical communication with the sensor on the second vehicle, the controller on the second vehicle configured to compute the location and the time that the route of the first vehicle and the route of the second vehicle intersect and to control a speed and a direction of the second vehicle;
wherein the controller of the first vehicle changes at least one of the speed and the route of the first vehicle such that the time that the first vehicle reaches the location that the route of the first vehicle and the route of the second vehicle intersect is different than the time that the second vehicle reaches the location that the route of the first vehicle and the route of the second vehicle intersect; and
wherein the controller changes at least one of the speed and the route of the first vehicle such that an acceleration of the first vehicle is optimized based on at least one of an acceleration bore by on-board cargo, a computed time to destination, an amount of fuel consumed, a vehicle throughput through the intersection, and a priority of the first vehicle and the second vehicle.
